(19) United States
(12) Patent Application Publication
(10) Pub. No.: US 2012/0219052 A1
(43) Pub. Date: Aug. 30, 2012

(54) PICTURE TRANSMISSION DEVICE, PICTURE TRANSMISSION METHOD, AND PROGRAM

(76) Inventor: Kensaku WAKUDA, Kanagawa (JP)

(21) Appl. No.: 13/399,590

(22) Filed: Feb. 17, 2012

(30) Foreign Application Priority Data
Feb. 24, 2011 (JP) 2011-038157

(51) Int. Cl. H04N 7/26

(52) U.S. Cl. 375/240.01; 375/E07.026

(57) ABSTRACT

Disclosed herein is a picture transmission device including a coding portion configured to code picture data to be transmitted, a rate acquisition portion configured to acquire the coding rate of the picture data to be coded by the coding portion, and a setting portion configured to set interlace scan or progressive scan as the scan type for the picture data to be coded in accordance with the coding rate acquired by the rate acquisition portion.

### BACKGROUND

The present disclosure relates to a picture transmission device, a picture transmission method, and a program.

Video data serving as picture data are exchanged between a plurality of devices via networks such as the Internet. The device on the transmitting side codes the video data before sending it to the device on the receiving side. The receiving device decodes the received video data before having it displayed by a suitable display device or the like for example.

Heretofore, the device that transmits video data varies its coding rate by taking the communication status of the network in use into consideration. In connection with the coding of video data, Japanese Patent Laid-Open No. 2005-151280 discloses a technique for varying the frame rate and resolution of video data in accordance with the coding rate in effect.

### SUMMARY

Meanwhile, some picture data targeted to be coded may be disrupted if the coding rate thereof is lowered below a certain level. For example, progressive scan picture data may not be able to keep its picture quality and may be disrupted if the coding rate involved is lowered.

The present disclosure has been made in view of the above circumstances and provides a picture transmission device, a picture transmission method, and a program newly improved in such a manner as to suitably code picture data while suppressing the disruption of the picture quality thereof in accordance with the type of the data.

According to an embodiment of the present disclosure, there is provided a picture transmission device including: a coding portion configured to code picture data to be transmitted; a rate acquisition portion configured to acquire a coding rate of the picture data to be coded by the coding portion; and a setting portion configured to set interlace scan or progressive scan as the scan type for the picture data to be coded in accordance with the coding rate acquired by the rate acquisition portion.

Preferably, the picture transmission device may further include a storage portion configured to store table information that associates the magnitude of the coding rate with the picture quality of the interlace scan picture data and that of the progressive scan picture data, the setting portion setting the interface scan or the progressive scan based on the acquired coding rate and on the table information stored in the storage portion.

Preferably, the storage portion may store the table information for each of different categories of the picture data, and the setting portion may set the interlace scan or the progressive scan based on the acquired coding rate and on the table information corresponding to the category of the picture data to be coded.

Preferably, the picture quality of the interlace scan picture data and that of the progressive scan picture data in the table information may be set by user-evaluated values.

Preferably, the setting portion may set the progressive scan if the acquired coding rate is higher than a predetermined threshold value, and may set the interlace scan instead if the acquired coding rate is lower than the predetermined threshold value. Preferably, the picture data to be coded may be moving picture data, the picture transmission device may further include a picture analysis portion configured to detect a scene change in the moving picture data, and the setting portion may set the interlace scan or the progressive scan in accordance with the coding rate at the time when the scene change is detected by the picture analysis portion.

Preferably, the predetermined threshold value may be a first threshold value, the setting portion may set the interlace scan or the progressive scan at the time of the scene change if the acquired coding rate is lower than a second threshold value higher than the first threshold value and is higher than a third threshold value lower than the first threshold value, and the setting portion may set the interlace scan or the progressive scan while the scene is not being changed if the acquired coding rate is higher than the second threshold value or is lower than the third threshold value.

Preferably, if no scene change is detected by the picture analysis portion, the setting portion may set the interlace scan or the progressive scan in accordance with the coding rate after the elapse of a predetermined time period since the comparison made between the coding rate and the predetermined threshold value.

According to another embodiment of the present disclosure, there is provided a picture transmission method including coding picture data to be transmitted, acquiring a coding rate of the picture data, and setting interlace scan or progressive scan as the scan type for the picture data to be coded in accordance with the acquired coding rate.

According to a further embodiment of the present disclosure, there is provided a program for causing a computer to execute a procedure including coding picture data to be transmitted, acquiring a coding rate of the picture data, and setting interlace scan or progressive scan as the scan type for the picture data to be coded in accordance with the acquired coding rate.

According to the above-described embodiments of the present disclosure, it is possible to suitably code picture data while suppressing the disruption of picture quality in accordance with the type of the picture data.

### BRIEF DESCRIPTION OF THE DRAWINGS

Further objects and advantages of the present disclosure will become apparent upon a reading of the following description and appended drawings in which:

FIG. 1 is a schematic view showing a configuration of a picture communication system;

FIG. 2 is a functional block diagram showing a structure of a picture transmission device;

FIG. 3 is a tabular view explanatory of a quality table;

FIG. 4 is a schematic view explanatory of a packet structure;

FIG. 5 is a functional block diagram showing a structure of a picture reception device;

FIG. 6 is a flowchart explanatory of a first example of a picture transmission process; and

FIG. 7 is a flowchart explanatory of a second example of the picture transmission process.

### DETAILED DESCRIPTION OF THE PREFERRED EMBODIMENTS

Some preferred embodiments of the present disclosure will now be explained in detail below with reference to the accompanying drawings. Throughout this specification and the appended drawings, the components that have substantially the same functional structures are designated by the same reference symbols, and the redundant descriptions will be omitted.

The explanation will be given under the following headings:

1. Outline of the picture communication system;
2. Structure of the picture transmission device;
3. Structure of the picture reception device;
4. Picture transmission process;

4-1. First processing example;

4-2. Second processing example; and

### 5. Conclusion.

### <1. Outline of the Picture Communication System>

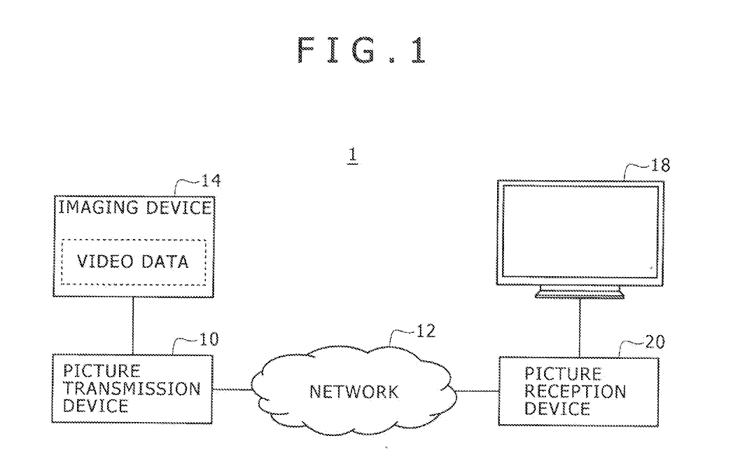

An outline of a picture communication system is explained below by referring to FIG. 1. FIG. 1 shows a typical configuration of a picture communication system 1.

As shown in FIG. 1, the picture communication system 1 includes a picture transmission device 10, a network 12, an imaging device 14, a display device 18, and a picture reception device 20.

The imaging device 14 may be a video camera for example. As such, the imaging device 14 takes pictures of an object to acquire picture data such as still pictures, moving pictures, etc. The imaging device 14 feeds the picture transmission device 10 with the picture data thus acquired.

The picture transmission device 10 codes the picture data supplied from the imaging device 14, generates packets containing the coded picture data, and transmits the packets thus generated to the picture reception device 20 via the network 12. Also, the picture transmission device 10 operates under TFRC (Transmission Control Protocol Friendly Rate Control). That is, upon receipt of feedback packets including such information as a packet loss rate and RTT (Round Trip Time) from the picture reception device 20, the picture transmission device 10 performs packet transmission control based on the received feedback packets. A detailed structure of the picture transmission device 10 will be discussed later.

The network 12 includes wired or wireless links to the information sent from the devices connected to the network 12. For example, the network 12 may include public line networks such as the Internet, telephone line networks and satellite communication networks; various LANs (local area networks) and WANs (wide area networks) including Ethernet (registered trademark).

The picture reception device 20 receives the packets sent from the picture transmission device 10 via the network 12, reconstructs picture data from the received packets, decodes the reconstructed picture data, and feeds the display device 18 with the decoded picture data. For example, the picture reception device 20 may generate feedback packets including information about the packet loss rate and transmit the feedback packets to the picture transmission device 10 via the network 12. A detailed structure of the picture reception device 20 will be discussed later.

The display device 18 displays the picture data fed from the picture reception device 20. The display device 18 may be a CRT (cathode ray tube) display device, a liquid crystal display (LCD) device, or an OLED (organic light-emitting diode) device, for example.

The picture communication system 1 structured as described above permits real-time communication of picture data. Thus the picture communication system 1 may be applied to a videophone system or a videoconference system, for example. Although FIG. 1 shows only a pair of communication devices (i.e., the picture transmission device 10 and the picture reception device 20), the picture communication system 1 may include more communication devices in practice.

Meanwhile, the picture communication system 1 varies the coding rate of the picture data transmitted to the picture reception device 20 in accordance with the communication status of the network 12. Some picture data to be coded may be disrupted if its coding rate is lowered below a certain level. For example, progressive scan picture data may not be able to keep its picture quality and may be disrupted if the coding rate involved is appreciably lowered. In order to solve this problem, the picture communication system 1 according to the present embodiment sets interlace scan or progressive scan as the scan type of picture data in accordance with the coding rate in effect, as will be discussed later in detail.

### <2. Structure of the Picture Transmission Device>

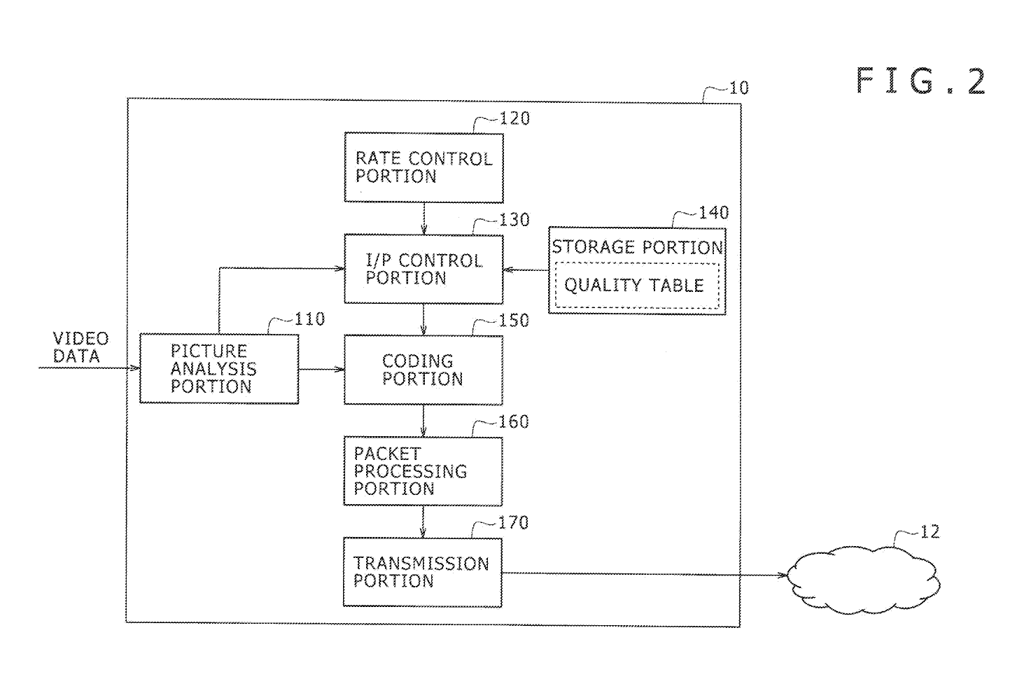

The structure of the picture transmission device 10 is explained below in reference to FIG. 2. FIG. 2 is a functional block diagram showing a typical structure of the picture transmission device 10.

As shown in FIG. 2, the picture transmission device 10 includes a picture analysis portion 110, a rate control portion 120 as an example of a rate acquisition portion, an I/P (Interlace/Progressive) control portion 130 as an example of a setting portion, a storage portion 140, a coding portion 150, a packet processing portion 160, and a transmission portion 170.

### (Picture Analysis Portion 110)

The picture analysis portion 110 performs image analysis of the picture data supplied from the imaging device 14. For example, the picture analysis portion 110 may analyze the picture data to determine the category thereof. After analyzing, the picture analysis portion 110 forwards the picture data to the coding portion 150 and the category information of the picture data to the I/P control portion 130.

Although the picture analysis portion 110 was described above as analyzing the picture data in order to determine its category, this is not limitative of the present disclosure. The category of the picture data may be determined by additionally using information such as metadata regarding the picture data or EPG (Electronic Program Guide), for example.

With this embodiment, the picture data fed from the imaging device 14 is moving picture data (video data) including a plurality of scenes. The picture analysis portion 110 is capable of detecting a scene change in the moving picture data. The picture analysis portion 110 supplies the I/P control portion 130 with information regarding the timing of the scene change thus detected.

### (Rate Control Portion 120)

The rate control portion 120 performs rate control so as to suppress network delays and packet losses on the packet-switching network. In UDP (User Datagram Protocol) communication, for example, the rate control portion 120 determines the coding rate of the picture data through TFRC. The rate control portion 120 supplies the rate thus determined to the I/P control portion 130.

### (I/P Control Portion 130 and Storage Portion 140)

The I/P control portion 130 sets interlace scan or progressive scan as the scan type for the picture data to be transmitted in accordance with the coding rate supplied from the rate control portion 120. More specifically, the I/P control portion 130 sets interlace scan or progressive scan based on the coding rate fed from the rate control portion 120 and on a quality table stored in the storage portion 140. That is, interlace scan or progressive scan is set as the scan type for the picture data to be transmitted based on user-level QoS (quality of service) as communication quality that a user experiences, i.e., on user's QoE (quality of experience), as will be discussed later in detail.

The storage portion 140 stores various items of data. The storage portion 140 stores the quality table as table information that associates the magnitude of the coding rate with the picture quality of interlace scan picture data and that of progressive scan picture data. The storage portion 140 stores the quality table for each category of picture data.

The quality table stored in the storage portion 140 is explained below in reference to FIG. 3. FIG. 3 is a tabular view explanatory of the quality table. A quality table is created through preliminary evaluations. The evaluations are performed using a plurality of video data items in different categories, and a plurality of quality tables are created corresponding to the categories involved.

A specific method of creating the quality table is explained here. The video data to be evaluated is first prepared, and coded into interlace scan video data and progressive scan video data at different coding rates. For example, the target coding rate may range from 5 to 30 Mbps, and the video data may be coded into interlace scan video data and progressive scan video data at intervals of 5 Mbps. Next, each video data is submitted to subjective evaluations involving a plurality of examinees (users) or to objective evaluations using evaluation tools. The evaluated values are normalized on a scale of 0 to 100, and the quality table such as one shown in FIG. 3 is created.

Next, the quality table shown in FIG. 3 is explained. In the quality table, the evaluated value 0 represents the worst picture quality of video data and the evaluated value 100 represents the best picture quality of video data. As can be seen in the quality table, when the coding rate is 15 Mbps or lower, the picture quality of interlace scan video data is higher than that of progressive scan video data. On the other hand, when the coding rate is 20 Mbps or higher, the picture quality of progressive scan video data is higher than that of interlace scan video data. As described, the picture quality of interlace scan picture data and that of progressive scan picture data in the quality table are set by user-evaluated values.

The evaluated value at a coding rate not included in the quality table of FIG. 3 (e.g., at 17 Mbps) may be interpolated from neighboring values. For example, if the coding rate is 17 Mbps, then linear interpolation carried out using 15 Mbps and 20 Mbps gives the evaluated value of 59.14 for progressive scan picture data and 67.54 for interlace scan picture data.

Incidentally, the video data to be evaluated in creating the quality table may include video data under diverse conditions such as moving pictures, near-still images, live-action images, animations, and computer graphics.

Details of the control executed by the I/P control portion 130 by use of the above-described quality table are explained below. From the quality table corresponding to the category determined by the picture analysis portion 110, the I/P control portion 130 acquires the evaluated value for progressive scan and the evaluated value for interlace scan corresponding to the acquired coding rate and compares the two values. If the progressive scan evaluated value is higher than the interlace scan evaluated value, the I/P control portion 130 sets progressive scan. If the progressive scan evaluated value is lower than the interlace scan evaluated value, then the I/P control portion 130 sets interlace scan. That is, the I/P control portion 130 sets the scan type with the better picture quality from the two candidates.

Also, the I/P control portion 130 sets interlace scan or progressive scan at the time of a scene change detected by the picture analysis portion 110. By limiting the timing of setting the scan type to the time when a scene is changed in the picture data, it is possible to suppress a conspicuous fluctuation of picture quality upon switching of the scan types.

Although the I/P control portion 130 was described above as comparing the progressive scan evaluated value with the interlace scan evaluated value in the quality table before setting progressive scan or interlace scan, this is not limitative of the present disclosure. Alternatively, for example, the I/P control portion 130 may set progressive scan or interlace scan depending on whether the acquired coding rate is higher or lower than a predetermined threshold value (stored in the storage portion 140).

For example, if the acquired coding rate is higher than a predetermined first threshold value (at which the progressive scan evaluated value is higher than the interlace scan evaluated value), the I/P control portion 130 may set progressive scan. If the acquired coding rate is lower than the predetermined first threshold value, the I/P control portion 130 may set interlace scan. In such a case, there is no need to store the quality table in the storage portion 140 so that the capacity of the storage portion 140 can be used effectively. Furthermore, since the scan type is determined solely by comparing the coding rate with the corresponding threshold value, the time for performing the process is shortened.

Alternatively, a plurality of threshold values may be set in steps for comparison with coding rates. For example, there may be set a second threshold value higher than the first threshold value and a third threshold value lower than the first threshold value. The second and the third threshold values may be used as follows:

If the acquired coding rate is higher than the second threshold value or lower than the third threshold value, the I/P control portion 130 sets interlace scan or progressive scan while the scene is not being changed. Specifically, if the coding rate acquired from the rate control portion 120 is higher than the second threshold value, the I/P control portion 130 forcibly sets progressive scan even when the timing of a scene change has yet to be reached. On the other hand, if the coding rate is lower than the third threshold value, the I/P control portion 130 forcibly sets interface scan even when the timing of a scene change has yet to be reached. This arrangement makes it possible rapidly to set the scan type suitable for the coding rate in effect. Furthermore, even if the coding rate is varied after the scan type is forcibly set as described above, a large fluctuation of the coding rate is not very conceivable, so that there is a low possibility that the scan type will be switched immediately thereafter.

Meanwhile, if the acquired coding rate is between the third and the second threshold values, the I/P control portion 130 sets interlace scan or progressive scan at the timing of a scene change. When the coding rate is found between the third and the second threshold values, the coding rate approaches the first threshold value or thereabout with a subsequent fluctuation, thereby the scan type is likely to be switched more frequently. Thus the frequent switching of the scan type can be suppressed by limiting the timing of setting the scan type as explained above.

Although the scan type was described above as getting set (switched) at the scene change timing, this is not limitative of the present disclosure. Alternatively, for example, if the picture analysis portion 110 does not detect a scene change, the I/P control portion 130 may, after the elapse of a predetermined time period, set interlace scan or progressive scan in accordance with the coding rate in effect. This can eliminate the possibility that the scan type is not switched appropriately for the coding rate when there is no scene change detected in the picture data.

### (Coding Portion 150)

The coding portion 150 codes the picture data supplied from the picture analysis portion 110. For example, the coding method may include JPEG (Joint Photographic Coding Experts Group), JPEG2000, Motion JPEG, AVC (Advanced Video Coding), MPEG-1 (Moving Picture Experts Group 1), MPEG-2, or MPEG-4.

The coding portion 150 codes picture data in accordance with the scan type set by the I/P control portion 130. For example, if the picture data fed from the picture analysis portion 110 is progressive scan data and if the I/P control portion 130 sets progressive scan, then the picture data is coded without the scan type thereof being changed. On the other hand, if the I/P control portion 130 sets interlace scan, then the scan type of the picture data is changed to interlace scan before the picture data is coded.

### (Packet Processing Portion 160)

The packet processing portion 160 generates packets based on the picture data coded by the coding portion 150, and feeds the packets thus generated to the transmission portion 170. Specifically, the packet processing portion 160 generates the packets by dividing the picture data coded by the coding portion 150 and attaching a TCP (Transmission Control Protocol)/IP header to each of the divided picture data. Alternatively, the packet processing portion 160 may generate the packets by attaching a UDP (User Datagram Protocol)/IP header to each of the divided picture data. The header includes a sequence number that identifies each packet.

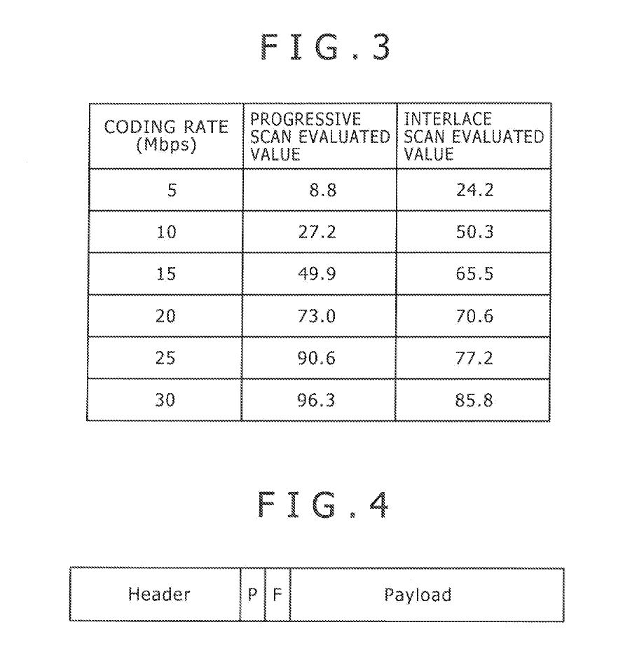

In order to notify the picture reception device 20 of the timing of I/P conversion, the packet processing portion 160 attaches a flag indicative of either progressive scan or interlace scan to each packet data when packetizing the coded picture data. The structure of the packet data generated by the packet processing portion 160 is explained here by referring to FIG. 4. FIG. 4 is a schematic view explanatory of a typical packet data structure. As shown in FIG. 4, the packet data includes a flag P and a flag F in addition to the header and a payload.

The flag P is a flag that indicates whether the packet data is progressive scan data or interlace scan data. For example, if the packet data is progressive scan data, the flag P is set to 0; if the packet data is interlace scan data, the flag P is set to 1. The flag F is a flag that indicates whether an odd-numbered field or an even numbered field is in effect when the packet data is interlace scan data. For example, if an even-numbered field is in effect, the flag F is set to 0; if an odd-numbered field is in effect, the flag F is set to 1. Where the packet data is progressive scan data, the flag F is not set. The packet processing portion 160 attaches the flags F and P to the packet data before feeding it to the transmission portion 170.

### (Transmission Portion 170)

The transmission portion 170 forwards the packet data fed from the packet processing portion 160 to the picture reception device 20 via the network 12.

In the above-described functional structure of the picture transmission device 10, the picture analysis portion 110, rate control portion 120, I/P control portion 130, coding portion 150, and packet processing portion 160 are constituted by an arithmetic processing unit such as a CPU (central processing unit) or a DSP (digital signal processor). The storage portion 140 is composed of a nonvolatile memory such as a flash memory, a hard disk drive, an external storage device such as a Blu-ray disk drive, or the like. The CPU loads programs retrieved from a ROM (read-only memory), the storage portion 140, an external storage device, or the like into a RAM (random access memory) for execution, thereby implementing various processes (including a picture transmission process to be discussed later). At least part of the above-described functional structure may be constituted by hardware such as a dedicated logic.

### <3. Structure of the Picture Reception Device>

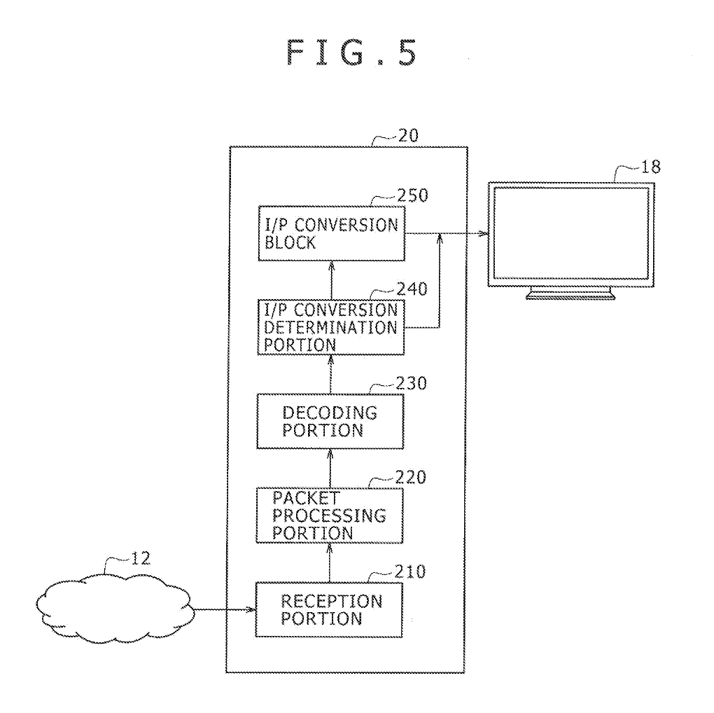

The structure of the picture reception device 20 will now be explained in reference to FIG. 5. FIG. 5 is a functional block diagram showing a typical structure of the picture reception device 20.

As shown in FIG. 5, the picture reception device 20 includes a reception portion 210, a packet processing portion 220, a decoding portion 230, an I/P conversion determination portion 240, and an I/P conversion block 250.

The reception portion 210 receives packets sent from the picture transmission device 10. The reception portion 210 forwards the received packets to the packet processing portion 220.

The packet processing portion 220 reconstructs picture data from the packet data supplied from the reception portion 210. That is, since each packet data contains divided picture data, the packet processing portion 220 reconstructs the picture data by combining the divided picture data from a plurality of packet data.

The decoding portion 230 decodes the picture data reconstructed by the packet processing portion 220. The decoding portion 230 supplies the decoded picture data to the I/P conversion determination portion 240.

Based on the value given by the flag P (see FIG. 4) attached to the packet data, the I/P conversion determination portion 240 determines whether or not to submit the decoded picture data for I/P conversion. For example, if the flag P is found set to 0 (i.e., if the scan type of the picture data is progressive scan), there is no need for I/P conversion, so that the I/P conversion determination portion 240 feeds the decoded progressive scan picture data to the display device 18. On the other hand, if the flag P is found set to 1 (i.e., if the scan type of the picture data is interlace scan), then I/P conversion is needed, so that the I/P conversion determination portion 240 supplies the decoded interlace scan picture data to the I/P conversion block 250.

The I/P conversion block 250 converts the interlace scan picture data fed from the I/P conversion determination portion 240 to progressive scan data. The I/P conversion block 250 supplies the progressive scan data thus converted to the display device 18.

The display device 18 displays in real time the progressive scan picture data supplied from the I/P conversion determination portion 240 or from the I/P conversion block 250. As described, a low-cost high-quality resolution changing process is made possible by utilizing the I/P conversion function incorporated in a TV set, a PC display monitor, a video card, etc.

Due to the processing time of the I/P conversion block 250, there may occur a discrepancy between the timing of displaying the picture data sent from the I/P conversion block 250 to the display device 18 on one hand, and the timing of displaying the picture data fed from the I/P conversion determination portion 240 to the display device 18 on the other hand. In such a case, the display timing discrepancy may be eliminated by buffering the picture data supplied from the I/P conversion determination portion 240 so as to delay the display.

Although the I/P conversion block 250 was described above as being included in the picture reception device 20 in this embodiment, this is not limitative of the present disclosure. Alternatively, for example, the I/P conversion block 250 may be installed in the display device 18.

### <4. Picture Transmission Process>

The process of transmitting the picture data according to this embodiment will now be explained. The picture transmission process is implemented by the CPU of the picture transmission device 10 executing a program stored in the storage portion 140. Below, a first and a second example of the picture transmission process will be discussed.

### (4-1. First Processing Example)

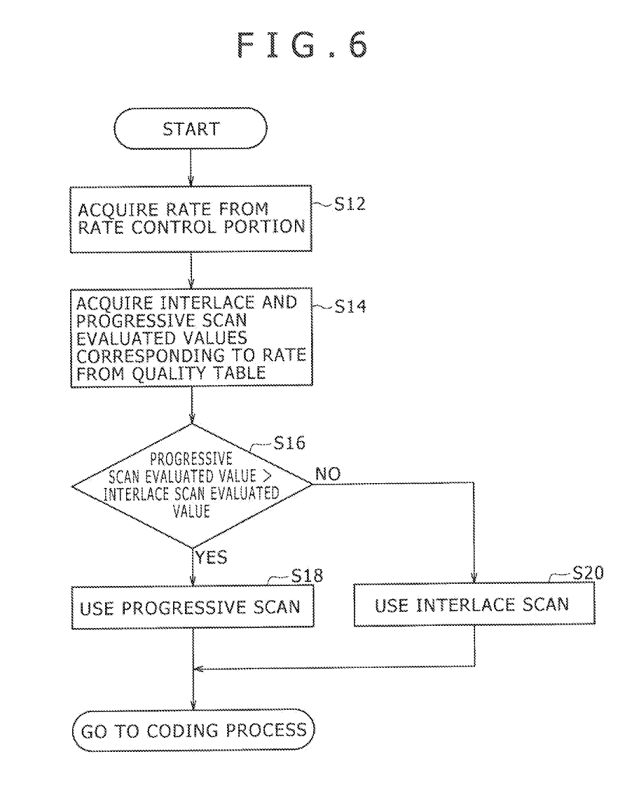

FIG. 6 is a flowchart explanatory of the first example of the picture transmission process. Execution of the flowchart in FIG. 6 is started when the picture analysis portion 110 of the picture transmission device 10 is supplied with picture data from the imaging device 14.

The rate control portion 120 first acquires the coding rate of the picture data in consideration of the communication status, etc. of the network 12 (step S12). The rate control portion 120 feeds the acquired coding rate to the I/P control portion 130.

Next, by referencing the quality table in the storage portion 140, the I/P control portion 130 acquires the interlace scan evaluated value and progressive scan evaluated value corresponding to the coding rate fed from the rate control portion 120 (step S14). If the value of the coding rate sent from the rate control portion 120 is not found in the quality table, the I/P control portion 130 acquires the corresponding interlace scan evaluated value and progressive scan evaluated value through the above-mentioned interpolation process.

Meanwhile, The storage portion 140 has a quality table stored for each of different categories, and the picture analysis portion 110 determines the category of the picture data upon image analysis thereof. From a plurality of quality tables stored in the storage portion 140, the I/P control portion 130 selects the quality table corresponding to the category determined by the picture analysis portion 110. The I/P control portion 130 references the selected quality table to acquire the corresponding interlace scan evaluated value and progressive scan evaluated value. In this manner, the scan type corresponding to the category of the picture data to be transmitted can be set highly accurately in real time.

The I/P control portion 130 then compares the acquired interlace scan evaluated value and the progressive scan evaluated value (step S16). If the comparison indicates that the progressive scan evaluated value is higher than the interlace scan evaluated value (Yes in step S16), the I/P control portion 130 sets progressive scan (step S18).

On the other hand, if the comparison indicates that the progressive scan evaluated value is lower than the interlace scan evaluated value (No in step S16), the I/P control portion 130 sets interlace scan (step S20).

The I/P control portion 130 supplies the coding portion 150 with information regarding the set scan type. The coding portion 150 codes the picture data according to the set scan type. For example, if the picture data fed from the picture analysis portion 110 is progressive scan data and if the I/P control portion 130 sets progressive scan, the coding portion 150 codes the supplied picture data without changing the scan type thereof. On the other hand, if the I/P control portion 130 sets interlace scan, the coding portion 150 switches the scan type of the picture data to interlace scan before coding the picture data. The coded picture data is packetized by the packet processing portion 160 before being transmitted to the picture reception device 20 by the transmission portion 170.

According to the above-described first processing example, it is possible suitably to code picture data while suppressing the disruption of picture quality thereof. What follows is a detailed explanation of what takes place when the imaging device 14 supplies progressive scan picture data to the picture transmission device 10.

In the case of progressive scan picture data, the higher the coding rate is involved, the higher the picture quality is as shown in FIG. 3. Thus if the coding rate set by the rate control portion 120 is low when the picture data supplied from the imaging device 14 is progressive scan data, the picture quality of the progressive scan picture data coded by the coding portion 150 may be disrupted. By contrast, according to the above-described first processing example, the scan type is switched from progressive scan to interlace scan if the coding rate involved is low, so that the picture quality of the picture data will not be disrupted despite the low coding rate in effect. If the coding rate is high, then progressive scan picture data is coded and transmitted to the picture reception device 20 with the high picture quality kept intact.

### (4-2. Second Processing Example)

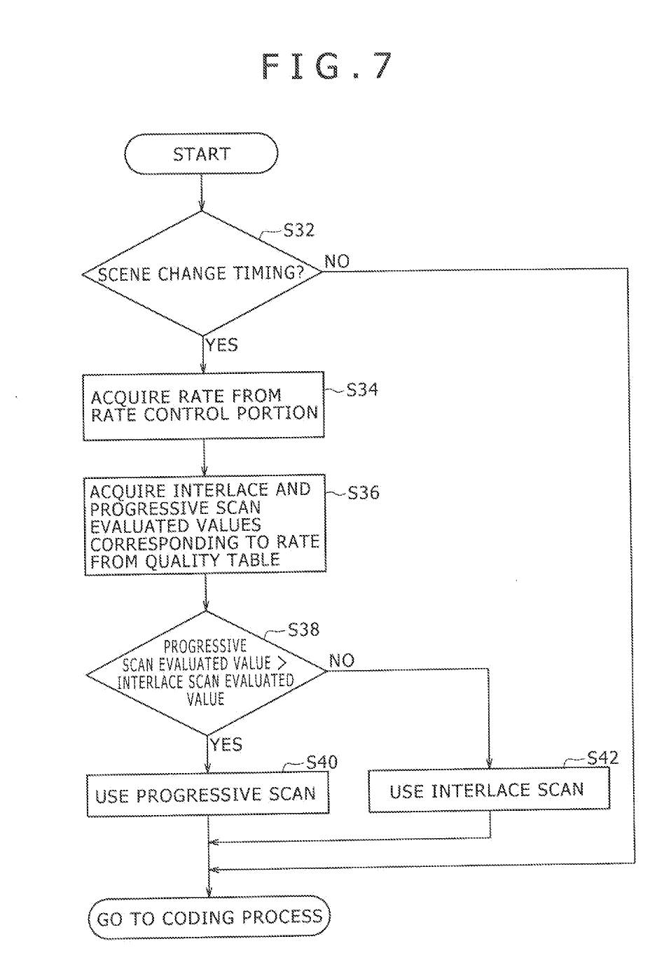

FIG. 7 is a flowchart explanatory of the second example of the picture transmission process. Execution of the flowchart in FIG. 7, as with that of the flowchart in FIG. 6, is started when the picture analysis portion 110 of the picture transmission device 10 is supplied with picture data from the imaging device 14.

In the above-described first processing example, given the picture data from imaging device 14, the I/P control portion 130 sets (switches) the scan type of the picture data. In the second processing example, by contrast, the I/P control portion 130 sets (switches) the scan type of the picture data only at the timing of a scene change in video data constituting the picture data.

In the second processing example, the picture analysis portion 110 first determines whether or not the timing of a scene change in the picture data is reached (step S32). If the picture analysis portion 110 determines that the timing of a scene change is reached (Yes in step S32), the I/P control portion 130 carries out steps S34 to S42 to set the picture data scan type corresponding to the coding rate in effect.

Steps S34 to S42 are substantially the same as steps S12 to S20 in FIG. 6. That is, the I/P control portion 130 sets interlace scan or progressive scan as the scan type of the picture data based on the coding rate and quality table in use. Thereafter, the coding portion 150 codes the picture data according to the set scan type. When implemented in this manner, the second processing example permits suitable coding of the picture data while suppressing the disruption of the picture quality thereof as in the case of the first processing example.

On the other hand, if the picture analysis portion 110 determines that the timing of a scene change has yet to be reached (No in step S32), the I/P control portion 130 does not switch the scan type of the picture data. In this case, the coding portion 150 keeps coding the picture data as per the same scan type until a scene change is detected.

According to the above-described second processing example, it is possible to switch interlace scan and progressive scan in accordance with the timing of a scene change in video data constituting the picture data. This makes it possible to prevent an increase of the number of times the scan type of picture data is switched. Particularly in the case of a coding rate at which the difference between the corresponding interlace scan evaluated value and progressive scan evaluated value is small (e.g., between 15 Mbps and 20 Mbps in the quality table of FIG. 3), the switching of the scan type is likely to occur frequently due to a subsequent fluctuation of the coding rate. This problem can be remedied by resorting to the second processing example. Also, this process can alleviate an uncomfortable feeling that may be experienced by the user when the scan type is frequently switched.

In the second processing example, the scan type of the picture data was described as being set corresponding to the coding rate in use if it is determined that the timing of a scene change is reached. However, this is not limitative of the present disclosure. Alternatively, for example, following the selection of the scan type of the picture data corresponding to the coding rate, it may be determined whether or not the timing of a scene change is reached, and the selected scan type may be put into effect at the timing of the scene change. That is, the switching to the selected scan type may be put on hold until the scene change timing is reached. If a different scan type (e.g., progressive scan) is newly selected while the previously-selected scan type (e.g., interlace scan) is being put on hold, the hold state as well as the switching of the scan type may be cancelled. In other words, the scan type in effect before the hold state (i.e., progressive scan) may be maintained.

### <5. Conclusion>

The picture transmission device 10 embodied as described above sets interlace scan or progressive scan as the scan type of the picture data to be sent to the picture reception device 20 via the network 12 in accordance with the coding rate supplied from the rate control portion 120. This makes it possible suitably to code the picture data while suppressing the disruption of the picture quality thereof. Specifically, when the coding rate is low, the scan type is switched from progressive scan to interlace scan so that the disruption of the picture quality of the picture data may be prevented. When the coding rate is high, progressive scan picture data is coded and transmitted to the picture reception device 20 with the high picture quality kept intact.

By switching the scan type of picture data, it is possible to vary the coding rate of the picture data more flexibly than before. That is, the coding rate may be arranged to be lowered for interlace scan picture data and raised for progressive scan picture data. This arrangement makes it less likely for network congestion to take place.

Also, because the quality table is used to set interlace scan or progressive scan, it is possible to make use of the picture quality experienced on the user level.

Furthermore, when a switching between interlace scan and progressive scan is made at the time of a scene change in video data, it is possible to suppress conspicuous changes in picture quality attributable to the switching. For example, when a switching from progressive scan to interlace scan is made at the timing of a scene change, a noticeable degradation of picture quality can be suppressed.

It should be understood by those skilled in the art that various modifications, combinations, sub-combinations and alterations may occur depending on design requirements and other factors insofar as they are within the scope of the appended claims or the equivalents thereof.

Also in this specification, the steps described as per the accompanying flowcharts represent not only the processes that are to be carried out in the depicted sequence on a time series basis, but also processes that may be performed in parallel or individually and not necessarily chronologically. Obviously, the steps processed on a time series basis can also be varied in sequence as the case may b

The present disclosure contains subject matter related to that disclosed in Japanese Priority Patent Application JP 2011-038157 filed in the Japan Patent Office on Feb. 24, 2011, the entire content of which is hereby incorporated by reference.

What is claimed is:

1. A picture transmission device comprising:
a coding portion configured to code picture data to be transmitted;
a rate acquisition portion configured to acquire the coding rate of said picture data to be coded by said coding portion; and
a setting portion configured to set interlace scan or progressive scan as the scan type for said picture data to be coded in accordance with said coding rate acquired by said rate acquisition portion.

2. The picture transmission device according to claim 1, further comprising:
a storage portion configured to store table information that associates the magnitude of said coding rate with the picture quality of the interlace scan picture data and that of the progressive scan picture data,
wherein said setting portion sets said interface scan or said progressive scan based on said acquired coding rate and on said table information stored in said storage portion.

3. The picture transmission device according to claim 2, wherein
said storage portion stores said table information for each of different categories of said picture data, and
said setting portion sets said interlace scan or said progressive scan based on said acquired coding rate and on said table information corresponding to the category of said picture data to be coded.

4. The picture transmission device according to claim 2, wherein the picture quality of said interlace scan picture data and that of said progressive scan picture data in said table information are set by user-evaluated values.

5. The picture transmission device according to claim 1, wherein
said setting portion sets said progressive scan if said acquired coding rate is higher than a predetermined threshold value, and
said setting portion sets said interlace scan if said acquired coding rate is lower than said predetermined threshold value.

6. The picture transmission device according to claim 5, wherein
said picture data to be coded is moving picture data,
said picture transmission device further includes a picture analysis portion configured to detect a scene change in said moving picture data, and
said setting portion sets said interlace scan or said progressive scan in accordance with said coding rate at the time when said scene change is detected by said picture analysis portion.

7. The picture transmission device according to claim 6, wherein
said predetermined threshold value is a first threshold value,
if said acquired coding rate is lower than a second threshold value higher than said first threshold value and is higher than a third threshold value lower than said first threshold value, said setting portion sets said interlace scan or said progressive scan at the time of said scene change, and
if said acquired coding rate is higher than said second threshold value or is lower than said third threshold value, said setting portion sets said interlace scan or said progressive scan while the scene is not being changed.

8. The picture transmission device according to claim 6, wherein, if no scene change is detected by said picture analysis portion, said setting portion sets said interlace scan or said progressive scan in accordance with said coding rate after the elapse of a predetermined time period since the comparison made between said coding rate and said predetermined threshold value.

9. A picture transmission method comprising:
coding picture data to be transmitted;
acquiring a coding rate of said picture data; and
setting interlace scan or progressive scan as the scan type for said picture data to be coded in accordance with said acquired coding rate.

10. A program for causing a computer to execute a procedure comprising:
coding picture data to be transmitted;
acquiring a coding rate of said picture data; and
setting interlace scan or progressive scan as the scan type for said picture data to be coded in accordance with said acquired coding rate.
